(19) United States
(12) Patent Application Publication
(10) Pub. No.: US 2025/0361048 A1
(43) Pub. Date: Nov. 27, 2025

(54) METHOD FOR OPENING A BOX AND FACILITY FOR IMPLEMENTING THE OPENING METHOD

(71) Applicant: Exotec Product France, Croix (FR)

(72) Inventor: Jean-Marie Ridez, Wimereux (FR)

(73) Assignee: Exotec Product France, Croix (FR)

(21) Appl. No.: 18/872,526

(22) PCT Filed: Jun. 7, 2023
(86) PCT No.: PCT/EP2023/065197

§ 371 Date: Dec. 6, 2024

(30) Foreign Application Priority Data
Jun. 7, 2022 (FR) FR2205431

(51) Int. Cl. B65B 69/00; B26D 1/04; B26D 7/18

(52) U.S. Cl. CPC B65B 69/0033; B26D 1/045; B26D 7/18

(57) ABSTRACT

The invention applies to a method for opening a box in which:
a box is placed at the entrance (12a) of a main conveyor (12),
the box (100) is brought into the cutting stattion (30) by means of the main conveyor (12);
a cut is performed in the upper wall (102) of the box
(100) along a cutting path by means of the cutting device (34), said cutting path (C) forming a continuous open loop including a continuous cutting line and at least one first uncut zone (x1) so as to obtain a cut wall part (110) which is connected to the body of the box (100) by at least one first connection portion (112,114); then
the cut box is brought into the discharge station (40) (12); then
the cut wall part (110) is seized by means of the gripping device (44) and the cut wall part (110) is detached from the body (101) of the box (100) by breaking the first connection portion; then
the cut wall portion (110) is discharged by means of the gripping device (44).

### TECHNICAL FIELD

The present disclosure relates to the field of opening boxes, particularly cardboard packing boxes. It relates in particular to an automated box opening method and the corresponding installation that is found for example in logistical centers or warehouses.

### PRIOR ART

In the past, cardboard boxes were opened manually in order to extract from them the articles and products transported. This manual work being time-consuming, sometimes dangerous and likely to damage the products contained in the boxes, logistical centers have gradually equipped themselves with installations for opening boxes automatically.

These installations implement opening methods in which a cutting tool, generally including a blade, performs continuous cuts or pre-cuts in the box.

Document EP 2 894 017 describes a box opening installation in which the box to be opened is first tilted. Then a suction cup holds a wall of the box while a blade mounted on an articulated arm performs a cut around the suction cup. After cutting the wall of the box, the suction cup is moved so as to open the wall of the box.

In this installation, the cutting of the face of the box and the opening are performed concomitantly. Although this type of arrangement can have an advantage in terms of bulk, it is nevertheless true that it has several disadvantages. In particular, maintenance interventions are complex and time consuming due to the accumulation of actuators and tooling in a reduced volume.

In addition, this installation requires tilting the box before proceeding with the cut, which is likely to cause a risk of breakage, for example in the case where the box contains fragile products.

### DISCLOSURE OF THE INVENTION

One object of the disclosure is to propose a method for opening a box correcting the aforementioned disadvantages and having greater facility of maintenance.

The object is achieved by a method for opening a box, in which:
an installation is provided comprising a main conveyor extending in a longitudinal direction and having a direction of travel and, considered in the direction of travel, the installation includes successively:
a cutting station including a cutting robot provided with a cutting device having a blade, and
a discharge station, located downstream of the cutting device, the discharge station including a gripping robot provided with a gripping device;
the opening method includes the following steps:
a box is placed at the entrance of the main conveyor, the box having a body closed by an upper wall;
the box is brought into the cutting station by means of the main conveyor;
a cut is performed in the upper wall of the box along a cutting path by means of the cutting device, said cutting path forming a continuous open loop which includes at least one first continuous cutting line and at least one first uncut zone so as to obtain a cut wall part which is connected to the body of the box by at least one first connection portion; then the cut box is brought into the discharge station by means of the main conveyor; then
the cut wall part is seized by means of the gripping device and the gripping device is moved in order to detach the cut wall part from the body of the box by breaking the first connection portion; then
the cut wall part is discharged by means of the gripping device.

It is understood that the steps of cutting and discharge are accomplished sequentially at two different stations which are distant from one another in the longitudinal direction, the two stations being located one downstream of the other in the direction of travel of the boxes on the main conveyor. The cut wall part is held to the rest of the box by the first connection portion during the transfer to the discharge station.

The cutting robot and the gripping robot include multi-axis robotic arms, well known, which are controlled by a control device.

Within the meaning of the disclosure, the upper wall is the wall of the top of the box which is generally horizontal.

The main conveyor is preferably a roller conveyor. It could also be a belt conveyor, these types of conveyors being well known.

Moreover, it is understood that the main conveyor includes a movement device for moving the boxes in the direction of travel.

According to the disclosure, the box is preferably of cardboard, or any other material of the same type. It has a generally parallelepiped shape.

The cutting path is preferably recorded in a memory, for example a memory of a controller or of the control device of the cutting robot.

Without departing from the scope of the present invention, the cutting device can include several blades.

It is understood, moreover, that the first connection portion is constituted by the matter of the first uncut zone of the upper wall which is not cut. This first connection portion constitutes a first severable attachment which holds the cut wall part to the rest of the box during its transfer to the discharge station.

Preferably, the cutting path has a generally rectangular shape, the edges of which are substantially parallel to the edges of the upper wall of the box.

It is understood that the gripping device seizes, then pulls on the cut wall part in order to tear the attachment, or the attachments, constituted by the first uncut zone, and if applicable by the second uncut zone.

The gripping device preferably includes suction cups connected to a suction device. The suction cups define a suction zone the surface of which can be modified depending on the size of the cut wall part to be seized and discharged.

The dimensions of the uncut zones will be selected so as to ensure easy detachment of the cut portion of the wall.

In certain embodiments, the length of the first uncut zone is equal at most to 10% of the length of the first continuous cutting line. Still preferably, the length of the first uncut zone is equal at most to 5% of the length of the first continuous cutting line. Still preferably, the length of the first uncut zone has less than 10% of the length of the cutting path. It is understood that the length of the cutting path is equal to the sum of the length of the first continuous cutting line and of the length of the first uncut zone when the open loop includes a single first uncut zone. Preferably, the length of the first continuous cutting line has at least 95% of the length of the cutting path.

In certain embodiments, the cut is performed so that the continuous open loop also includes a second continuous cutting line and a second uncut zone, so that the cut wall part is connected to the body of the box by the first connection portion and by a second connection portion, the first and second continuous cutting lines being separated from one another by the first and second connection portions.

It is understood that the continuous loop is open in two zones which correspond to the first and second uncut zones.

The cutting path, forming the continuous open loop, is therefore constituted in this variant by first and second continuous cutting lines, and first and second uncut zones. The length of the second uncut zone is at most equal to 10% of the length of the second continuous cutting line. Still preferably, the length of the second uncut zone is equal at most to 5% of the length of the second continuous cutting line.

In this variant, the length of the cutting path is equal to the sum of the length of the first and second continuous cutting lines and of the lengths of the first and second uncut zones. The sum of the lengths of the first and second continuous cutting lines is at most 95% of the length of the cutting path.

It is understood that the second connection portion constitutes a second severable attachment; the first and second severable attachments hold the cut wall part. Due to the presence of the second connection portion, the cut wall part is better held and remains substantially horizontal before the discharge step.

Preferably, the first and second connection portions are produced so as to be positioned at two opposite edges of the cut wall part.

In certain embodiments, the installation also includes a measurement station located upstream of the cutting station, the measurement station including at least one measurement device, and in which the dimensions of the box are measured by means of the measurement device, and the cutting path is determined based on the dimensions measured by the measurement device.

The box is preferably measured along three dimensions: its height, its length and its width. Preferably, the height of the box is measured, and the length and the width of the upper wall.

According to a preferred embodiment, the coordinates of the cutting path are calculated based on the dimensions of the box measured by the measurement device.

Preferably, the coordinates of the cutting path are calculated by means of a computer so that the distance between the longitudinal edge and/or the transverse edge of the upper wall to be cut and the cutting path is equal to a predetermined value. This value is previously entered and/or recorded in the computer. This value can be a constant or a percentage of the measured length of one of the edges of the box.

Preferably, the distance between the cutting path and the longitudinal edge is identical to the distance between the cutting path and the transverse edge of the upper wall. Without departing from the scope of the present invention, it will be possible to select different distances by configuring different predetermined values for the longitudinal and transverse edges of the box.

The measurement device preferably includes a laser profilometer.

Preferably, the position of the box in a horizontal plane is corrected before the measurement step. One advantage is to improve the accuracy of measurement but also to correct the position of the box before its conveyance into the cutting station.

The position correction is accomplished so that one of the edges of the box is parallel to the direction of travel of the main conveyor.

In certain embodiments, the position of the box is corrected in a horizontal plane in the cutting station prior to the step of cutting the upper wall. This step allows better positioning of the cut in the upper wall and ensures the reproducibility of the cut.

In certain embodiments, the installation also includes a secondary conveyor, and the cut wall part is discharged on the secondary conveyor by means of the gripping device.

It is understood that the gripping device detaches the cut wall part, then brings it to the secondary conveyor. The secondary conveyor can for example be associated with a receptacle for receiving the cut parts of the boxes.

According to a preferred embodiment, between two successive cuts of two boxes, an image of the blade is acquired by means of an image acquisition device mounted on the cutting device and wear or breakage of the blade is determined based on said image.

The image acquisition device preferably includes a camera. The image acquisition device is preferably connected to an analysis device configured to determine the wear or the breakage of the blade based on the image acquired by the image acquisition device. When the blade has several cutting edges, the image acquisition device can also be configured to acquire and image of the cutting edges and the wear of each of the cutting edges of the blade is determined. The wear or the breakage of the blade and/or of the cutting edges can be determined by an automated method implementing a step of comparing the image of the blade, or its shadow, with an image of an unworn blade.

In an exemplary embodiment, the blade has a first cutting edge and a second cutting edge opposite to the first cutting edge. The cut is first accomplished with the first cutting edge. When the first cutting edge has considerable wear, for example exceeding a predetermined threshold such as a threshold of blade surface consumed, determined by a computer based on the image of the blade, the cutting device is pivoted 180° so as to continue the cut by using the second cutting edge. It is understood that the pivoting by 180° of the cutting device allows bringing the second cutting edge into the cutting position.

In certain exemplary embodiments, the installation also includes a replacement blade magazine which is located in a drawer adjacent to the cutting robot, and the worn or broken blade is replaced by a replacement blade in the event of breakage or if the determined wear is greater than a predetermined threshold.

The blade magazine includes several replacement blades. It also allows receiving the worn blades.

The drawer is arranged so that only the cutting robot can have access to the replacement blade magazine when the drawer is closed, while only the operator can have access to the magazine when the drawer is open, for example to place new blades there and to withdraw worn blades. This advantageous arrangement allows improving the safety of the operator.

In certain embodiments, the cutting device includes two cutting depths, and a thickness datum representing the thickness of the upper wall is transmitted to the cutting robot and the cutting depth is selected based on the thickness datum.

The thickness datum is preferably but not exclusively transmitted to the control device of the cutting robot by a control signal originating in an external control unit at the installation.

Without departing from the scope of the present disclosure, the cutting device could include additional cutting depths, in order to adapt itself to different wall thicknesses.

The disclosure also relates to an installation for the implementation of the method according to the disclosure, comprising a main conveyor extending in a longitudinal direction and having a direction of travel and, considered in the direction of travel, the installation includes successively:
a cutting station including a cutting robot provided with a cutting device having a blade, and
a discharge station, located downstream of the cutting station, the discharge station including a gripping robot provided with a gripping device.

In certain embodiments, the blade has a triangular shape having a first cutting edge and a second cutting edge opposite to the first cutting edge.

In certain embodiments, the installation according to the disclosure also comprises a measurement station located for example in the cutting station, the measurement station including a measurement device for measuring the dimensions of the box.

The measurement device preferably includes a laser profilometer which allows determining the dimensions of the box, namely the length, the width and the height. The profilometer allows determining the length and the width of the upper wall of the box.

The installation also includes a computer for calculating the coordinates of the cutting path. As indicated above, the coordinates of the cutting path depend on the width and on the length of the upper wall and also on at least one predetermined value allowing fixing the distance between the cutting path and the longitudinal and transverse edges of the upper wall.

According to certain embodiments, the installation also includes a secondary conveyor, parallel to the main conveyor, and in which the gripping robot is located between the main conveyor and the secondary conveyor.

The secondary conveyor preferably includes a clinging or non-slipping belt, of PVC for example, allowing ensuring that the cut wall parts do not fall from the secondary conveyor.

The secondary conveyor preferably but not exclusively has a movement direction opposite to the direction of travel of the main conveyor.

The secondary conveyor can be associated with a trash conveyor.

In certain embodiments, the cutting device includes two cutting depths.

The cutting device therefore allows adapting to the thickness of the upper wall to be cut. Preferably, the cutting device includes a bearing member configured to bear against the upper face of the box to be cut, the blade being movable relative to the bearing member so as to modify the cutting depth.

Preferably, the cutting device includes an image acquisition device for acquiring an image of the blade. Still preferably, the installation includes an analysis device for determining the wear of the blade based on the image acquired by the image acquisition device. By way of an example, the acquired image is compared to an image of a new blade so as to identify, by comparison, a breakage or a worn part. The comparison can in particular consist of determining, with a computer, the consumed surface of the worn blade relative to an image of a new blade. A predetermined wear threshold can be selected in order to determine when the blade should be replaced.

Advantageously, and for reasons of safety, the installation according to the disclosure also includes an enclosure in which are located the cutting station and the gripping station, and a replacement blade magazine located in a drawer sliding in an opening provided in the enclosure. It is understood that the enclosure is preferably crossed by the main conveyor.

Preferably, the gripping device includes suction members. The suction member defining a suction surface can be separately actuated so as to modulate the suction surface depending on the surface of the cut part of a wall to be discharged.

### DESCRIPTION OF THE DRAWINGS

The invention will be better understood upon reading the description that follows of an embodiment of the disclosure given by way of a non-limiting example, with reference to the appended drawings, in which:

FIG. 1 is a perspective view of an embodiment of the box opening installation according to the disclosure implementing the method according to the disclosure;

FIG. 2 is a detail view of a measurement station of the installation of FIG. 1;

FIG. 3 is a detail view of the cutting station of the installation of FIG. 1;

FIG. 4 illustrates in top view and schematically a device for correcting the position of boxes in the cutting station;

FIG. 5 illustrates in top view the upper face of the box after the cutting operation;

FIG. 6 is a detail view of the replacement blade magazine;

FIG. 7 illustrates the transfer of the cut box between the cutting station and the discharge station;

FIG. 8 is a detail view of the discharge station;

FIG. 9 illustrates in top view and schematically the cut box on the main conveyor and the wall portion that has been discharged on the secondary conveyor; and

FIG. 10 is a detail view of the device for acquiring images of the blade.

### DETAILED DESCRIPTION

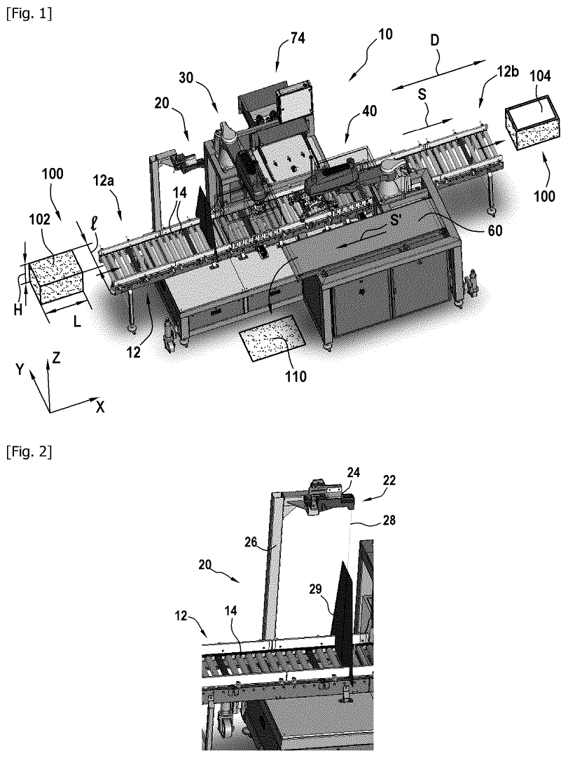

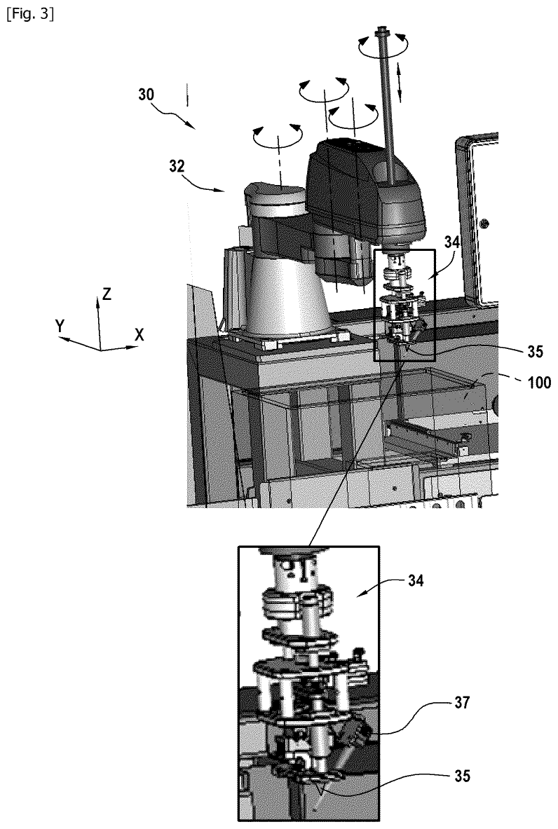

An installation 10 for opening boxes, particularly cardboard boxes containing articles, will be described by means of FIGS. 1 to 10, and the method for opening a box which is implemented by this installation.

In this example, the boxes are cardboard boxes having a generally parallelepiped shape, well known, and which are traditionally used for transporting articles. The installation 10 has as its function to automatically open such boxes, and more precisely an upper face 102 of the box. The installation 10 receives at its entrance a box 100, supplies at its exit a box of which the upper face 102 has an opening 104.

The installation 10 comprises a main conveyor 12, in this example a roller conveyor 14, which extends in a longitudinal direction D and which has a direction of travel S between an upstream part 12a and a downstream part 12b of the main conveyor 12.

Shown in several of the figures is a reference frame XYZ. The longitudinal direction D is parallel to the axis X, the width of the main conveyor extends along the axis Y and the axis Z is vertical.

The rollers 14 of the main conveyor 12 are driven in rotation by drive means, well known and not illustrated here.

In the description that follows, the terms upstream and downstream will be considered with reference to the direction of travel S.

Considered in the direction of travel S, from upstream to downstream, the installation 10 according to the exemplary embodiment includes successively: a measurement station 20, a cutting station 30 and a discharge station 40. It is understood that the box is initially deposited at the upstream part 12a of the main conveyor 12, i.e. upstream of the measurement station 20. The open box leaves by the downstream part 12a of the discharge station 40.

It is understood moreover that the measurement station 20 is located upstream of the cutting station 30, while the discharge station 40 is located downstream of the cutting device 30. Referring to FIG. 1, it is understood that the discharge station is located at a distance from the cutting station, considered in the direction of travel S.

The installation 10 includes, in this exemplary embodiment, at least one device 50 for correcting the position of the box on the main conveyor 12. Such a correction device 50 can be placed at several locations of the main conveyor, for example in the cutting station and/or in the discharge station.

By means of FIG. 2, the measurement station 20 will be described. This measurement station 20 includes a measurement device 22 for measuring the dimensions of the box 100, namely the length and the width of the upper wall, and the height of the box.

To this end, in this example, the measurement device 22 includes a laser profilometer 24 mounted at the upper end of an arm 26. The laser beam is shown schematically by the line 26 while the greyed surface 29 illustrates the surface swept by the laser beam.

The measurement device 22 is connected to a controller of the installation.

Located downstream of the measurement station, the cutting station 30 includes a cutting robot 32 provided with a cutting device 34 comprising a blade 35. In this example, the blade 35 has a triangular shape and comprises a first cutting edge and a second cutting edge opposite to the first cutting edge.

The cutting robot 32 is, in this example, a multi-axis Fanuc brand robot which allows moving the cutting device 34 in space in the directions X, Y and Z. The cutting device 34 includes, in this example, two cutting depths in order to adapt itself to the thickness of the upper wall 102. It is specified that, in this example, the information relating to the thickness of the upper wall is supplied to the control device of the installation, for example via an external signal.

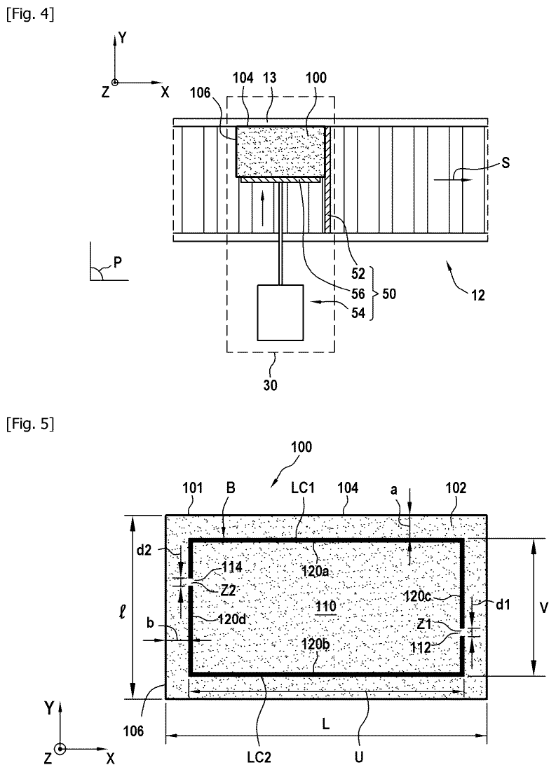

According to the method of the disclosure, the box is brought into the cutting station 30 by means of the main conveyor 12. In this example, the position of the box 100 is corrected first of all by means of a position correction device 50 illustrated in FIG. 4.

The position correction device 50 includes a first retractable stop 52 which extends along the width of the main conveyor 12, oriented along the axis Y. This first stop 52 has as its function to stop the movement of the box 100 in the direction of travel S. Moreover, the position correction device includes an actuator 54 provided with a plate 56 which is movable along the axis Y so as to push the box 100 against an edge 13 of the main conveyor 12 and which extends parallel to the longitudinal direction of the conveyor. It is understood that the position correction device allows aligning one of the lateral walls 104 of the box parallel to the axis X, and a second lateral wall, perpendicular to the first lateral wall 104, parallel to the axis Y.

After correction of the position, a cut is performed in the upper wall 102 of the box 100 along a cutting path B by means of the cutting device 34. Referring to FIG. 5, it is noted that the cutting path B forms a continuous open loop including a first continuous cutting line LC1 and a second continuous cutting line LC2. The continuous open cutting loop also includes a first uncut zone Z1 and a second uncut zone Z2, the first and second uncut zones Z1, Z2 separating the first and second continuous lines LC1, LC2.

By means of FIG. 5, it is understood that the cutting path B delimits a cut wall part 104 from the rest of the body 101 of the box 100. More precisely, the cut wall part 104 remains connected to the body 101 of the box 100 by a first connection portion 106 formed by the first uncut zone Z1, and by a second connection portion 108 which is formed by the second uncut zone Z2. The first and second connection portions constitute severable attachments which have as their function to hold the cut wall part integral with the rest of the box during the transfer from the cutting station to the discharge station.

It is specified that the thickness of the cutting path B illustrated in FIG. 5 is deliberately exaggerated in order to facilitate understanding.

In this example, the cutting path B has a generally rectangular shape, of which the longitudinal and transverse edges as presented are substantially parallel to the lateral walls 104 and 106 of the box. The cutting path B has a length U and a width V.

The cutting path B forms an open loop which, in this example, is constituted by two continuous cutting lines, namely a first continuous cutting line LC1 and a second continuous cutting line LC2 which are separated from one another by the first and second connection portions 112, 114. In the example of FIG. 5, the first and second connection portions 112, 114 are located in the transverse edges of the cutting path. Without departing from the scope of the present invention, the first and second connection portions could be produced at other locations, provided that they allow holding the cut wall part 110 sufficiently horizontal to facilitate the subsequent discharge operation.

Moreover, the sum of the lengths of the first and second continuous cutting lines LC1, LC2, namely 2*(U+V)-d1-d2, represents at least 90% of the length of the cutting path B, namely 2*(U+V).

The length d1 of the first uncut zone Z1 is, in this example, less than 10% of the length of the first continuous cutting line LC1. Moreover, the sum of the lengths d1, d2 of the first and second uncut zones Z1,Z2 is less than 10% of the sum of the length of the first and second continuous cutting lines LC1, LC2.

Moreover, it is noted that the cut wall part 110 has two longitudinal edges 120a, 120b, and two transverse edges 120c, 120d.

It is noted that the longitudinal edge 120a of the cutting path is located at a distance a from the longitudinal edge 104 of the upper wall, while the transverse edge 120c of the cutting path is located at a distance b from the transverse edge 106 of the upper wall. The distances a and b are configured in the control device of the cutting device. This can be a constant value, for example on the order of a few centimeters, or a value that is calculated based on the length L or on the width [symbol] of the box measured by the measurement station.

It is specified that the method according to the invention allows producing openings in the upper wall of boxes without knowing a priori the dimensions of the box to be cut, provided that the cutting path is determined based on dimensions measured by the measurement device. In other words, the box opening method is adapted to the dimensions of the box that enters the installation.

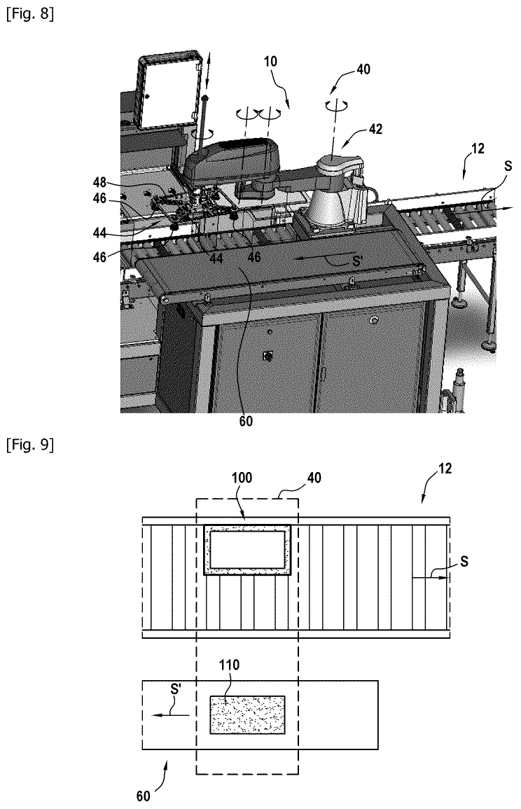

After the cutting operation, the stop 52 is retracted, following which the box 100 continues its movement on the main conveyor 12 in the direction of travel S toward the discharge station 40 which is located downstream of the cutting device, as shown schematically in FIG. 7. Referring to FIG. 8, the discharge station 40 will be described in greater detail.

The discharge station 40 includes a gripping robot 42, similar in this example to the cutting robot, the gripping robot 42 being provided with a gripping device 44.

The gripping device 44 includes suction members 46 appearing in the form of suction cups which are carried by a frame 48. The frame 48 carries several suction members 46 so as to be able to seize cut wall parts having different sizes.

According to the invention, the cut wall part 110 is seized by means of the gripping device 44, by activating the suction members, and the gripping device is moved in order to detach the cut wall part from the body 101 of the box 100 by breaking or tearing the first or second severable attachments constituted by the first and second connection portions 112, 114.

To this end, after having seized the cut wall part 110, the gripping device 44 is moved upward so as to tear the first and second connection portions, after which the cut wall part 110 is separated from the rest of the box. Then the cut wall part 110 is discharged by means of the gripping device 44 on a secondary conveyor 60 by means of the gripping device 44.

In this example, the secondary conveyor 60, illustrated in FIG. 9, extends parallel to the longitudinal direction D of the main conveyor 12. It has a direction of travel S′ which is opposite to the direction of travel S of the main conveyor 12. The secondary conveyor is a belt conveyor which includes, in this example, a clinging belt, of PVC for example, so as to prevent the cut wall parts from falling from the secondary conveyor.

The secondary conveyor 60 can also be associated with a trash conveyor, located downstream of the secondary conveyor S′.

Moreover, the gripping robot 42 is located between the main conveyor 12 and the secondary conveyor 60, which allows facilitating the discharge of the cut wall part while limiting the transverse bulk of the installation.

According to the disclosure, the installation also includes an image acquisition device 39 for acquiring an image of the blade 35.

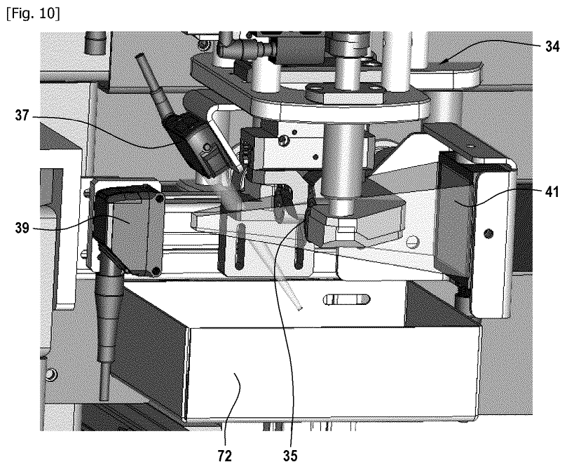

This image acquisition device 39 is, in this example of FIG. 10, located in the cutting station and associated with a backlighting device 41. The cutting device is brought between the image acquisition device 39 and the backlighting device 41 during the acquisition of the image of the blade.

The images taken by the image acquisition device 39 are transmitted to a breakage or wear detection device comprising a computer which compares the image of the blade 35, or its shadow, with a profile of a new blade so as to determine, by comparison of shapes, the state of wear or breakage of the blade. The acquisition of the image of the blade and the analysis of the level of wear or the detection of breakage is preferably but not necessarily accomplished between two successive cuttings of two boxes.

The comparative analysis therefore allows determining a level of wear of the blade 35, or its breakage.

The blade will be replaced if its level of wear exceeds a predetermined threshold. The level of wear can for example be a wear rate corresponding to a ratio between the shape of the worn blade, determined by imaging, and the shape of a new blade.

Moreover, the installation 10 includes an enclosure 70 in which are located at least the cutting station 30 and the discharge station 40 and a replacement blade magazine 72 which is housed in a drawer mounted sliding in an opening 76 provided in the enclosure 70.

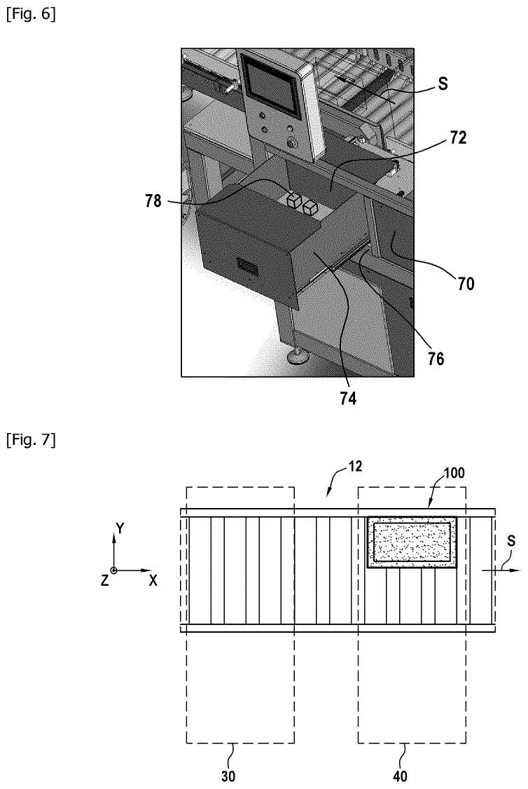

The magazine 72 includes replacement blades 78 as well as locations for receiving the worn blades. When the drawer is open, as illustrated in FIG. 6, the operator can place replacement blades 78 in the drawer and withdraw the worn blades replaced by the cutting robot.

When the drawer is closed, the replacement blade magazine is located inside the enclosure and the cutting device can deposit a worn blade and seize a new blade.

To this end, the cutting device includes a controllable jaw allowing blades to be seized.

Preferably, the detection of wear or of breakage of the blade is accomplished while the cutting device 34 is located above the replacement blade magazine 72. One advantage is to be able to rapidly change the blade if the breakage or wear detection device detects considerable breakage, necessitating replacing the blade with a new blade.

Moreover, as illustrated in FIG. 10, the installation includes a blade presence sensor 37, mounted on the cutting head, the function of which is to ascertain the presence of a replacement blade in the replacement blade magazine.

The detection of the presence of a new blade in the magazine is accomplished by means of the blade presence sensor 37 when the cutting device 34 is located above the replacement blade magazine 72.

1. A method for opening a box, comprising:
providing an installation having a main conveyor extending in a longitudinal direction and having a direction of travel and, considered along the direction of travel, the installation successively includes:
a cutting station including a cutting robot provided with a cutting device having a blade, and
a discharge station, located downstream of the cutting station, the discharge station including a gripping robot provided with a gripping device;
placing a box at the entrance of the main conveyor, the box having a body provided with an upper wall;
bringing the box into the cutting station by using the main conveyor;
performing a cut in the upper wall of the box along a cutting path by means of using the cutting device, said cutting path forming a continuous open loop including at least one first cutting line and at least one first uncut zone so as to obtain a cut wall part which is connected to the body of the box by at least one first connection portion; then
bringing the cut box into the discharge station by using the main conveyor; then
seizing the cut wall part by using the gripping device and moving the gripping device in order to detach the cut wall part from the body of the box by breaking the first connection portion; then
discharging the cut wall part by using the gripping device.

2. The method according to claim 1, wherein the length of the first uncut zone is equal at most to 10% of the length of said first continuous cutting line.

3. The method according to claim 1, wherein the cut is performed so that the continuous open loop also includes a second continuous cutting line and a second uncut zone, so that the cut wall part is connected to the body of the box by the first connection portion and by a second connection portion, the first and second continuous cutting lines being separated from one another by the first and second connection portions.

4. The method according to claim 1, wherein the installation further includes a measurement station located upstream of the cutting station, the measurement station including at least one measurement device, and wherein the dimensions of the box are measured by using the measurement device, and the cutting path is determined based on the dimensions measured by the measurement device.

5. The method according to claim 1, wherein the position of the box in a horizontal plane is corrected prior to the step of cutting the upper wall.

6. The method according to claim 1, wherein the installation further includes a secondary conveyor, and wherein the cut wall part is discharged on the secondary conveyor by using the gripping device.

7. The method according to claim 1, further comprising, between two successive cuts of two boxes, acquiring an image of the blade by using an image acquisition device mounted on the cutting device and determining the wear or breakage of the blade based on said image.

8. The method according to claim 7, wherein the installation also comprises a replacement blade magazine located in a drawer adjacent to the cutting robot, and the worn or broken blade is replaced by a replacement blade in the event of breakage or if the determined wear is greater than a predetermined threshold.

9. The method according to claim 1, wherein the cutting device includes two cutting depths, wherein a thickness datum representing the thickness of the upper wall is transmitted to the cutting robot and the cutting depth is selected based on the thickness datum.

10. An installation for the implementation of the method according to claim 1, comprising a main conveyor extending in a longitudinal direction and having a direction of travel and, considered in the direction of travel, the installation includes successively:
a cutting station including a cutting robot provided with a cutting device having a blade, and
a discharge station, located downstream of the cutting device, the discharge station including a gripping robot provided with a gripping device.

11. The installation according to claim 10, further comprising a measurement station located in the cutting station, the measurement station including a measurement device for measuring the dimensions of the box.

12. The installation according to claim 10, further including a secondary conveyor, parallel to the main conveyor, and wherein the gripping robot is located between the main conveyor and the secondary conveyor.

13. The installation according to claim 10, wherein the cutting device includes two cutting depths.

14. The installation according to claim 10, wherein the cutting device includes an image acquisition device for acquiring an image of the blade.

15. The installation according to claim 10, further including an enclosure in which are located the cutting station and the discharge station, and a replacement blade magazine located in a drawer which is mounted sliding in an opening provided in the enclosure.

16. The installation according to claim 10, wherein the gripping device includes suction members.
